(19) United States
(12) Patent Application Publication
(10) Pub. No.: US 2016/0302995 A1
(43) Pub. Date: Oct. 20, 2016

(54) CONSTRUCTIVE DISPOSITION INTRODUCED IN PHYSIOTHERAPY ELECTROMECHANICAL APPARATUS OF LYMPHATIC DRAINAGE FOR UPPER LIMBS

(71) Applicant: Jose Maria Pereira de Godoy, Sao Jose do Rio Preto (BR)

(72) Inventor: Jose Maria Pereira de Godoy, Sao Jose do Rio Preto (BR)

(21) Appl. No.: 14/975,127

(22) Filed: Dec. 18, 2015

(30) Foreign Application Priority Data
Apr. 15, 2015 (BR) 20 2015 008128 1

(51) Int. Cl. A61H 23/00

(52) U.S. Cl. CPC A61H 23/004

(57) ABSTRACT

“CONSTRUCTIVE DISPOSITION INTRODUCED IN PHYSIOTHERAPY ELECTROMECHANICAL APPARATUS OF LYMPHATIC DRAINAGE FOR UPPER LIMBS,” more precisely it is electromechanical device (1) of the type used in the treatment of lymphedema or other similar diseases; the said apparatus (1) provides associated mechanisms, with the electromechanical module (M1) formed by a printed circuit board (PCI) and idealized for actuating the mechanical module (M2), which in turn imposes movement to a rod (B), which is connected to the support platform (PL) of the upper member; the said platform (PL) promotes angular and repetitive motion of the upper limb; the said electromechanical mechanism (M1) and mechanism (M2) to be packed in compact fairing (2) of rectangular prism shape and configured by a receptacle (2A) of low height (x), width (y) and length (z) in which flat bottom (2a1) is installed the printed circuit board (PCI), which is connected to a digital control panel (3) controller of all the functions of the apparatus (1), wherein the said panel (3) is disposed in cutout (2b1) carried on one of the side walls (2b) of the receptacle (2A), whereas the mechanical module (M2) formed by the gearmotor (4) that drives the eccentric shaft system (5), which imposes rotating movements to the rod (B); the said receptacle (2A) provides in the top wall (2c) recess (2c1) for centralized installation of the mechanical module (M2) and thus fixing of the rod (B) in an orthogonal branch (7) extending from the lower face of the platform (PL); assembly of the modules (M1) and (M2) in the fairing (2) configure a spatial area (AE) wide and centered to the angular movement of the support platform (PL) of the upper member.

### TECHNICAL FIELD

This application relates to a new constructive disposition introduced in physiotherapy electromechanical apparatus of lymphatic drainage for upper limbs, which, notably, the said apparatus features innovative construction that provide improvements in the performance of physiotherapy movements for flexion and extension of the areas of arms and forearms, aimed at stimulation of veno-lymphatic return and treatment of lymphedema for intensive use as monotherapy.

### BACKGROUND

It is known that the type of lymphedema consists in a swelling, or edema that occurs in a body part caused by abnormal accumulation of liquids and substances, especially proteins, in tissues, resulting in the poor functioning of the lymphatic drainage system, and the lymphedema may be due to a problem between the lymphatic flow produced and transport capacity.

Among the main causes of lymphedema, it may be mentioned the congenital, where the patient already provides dysfunction, infectious lymphedema resulting from resulting from lymphatic vessel destruction, by infectious processes of the skin and subcutaneous tissue, lymphedema after radiation therapy or after some types of surgery, such as mastectomy and tumors.

Lymphedema may be classified according to the reversibility or irreversibility of features, namely: i) 1st degree—consists of reversible lymphedema with elevation of the member and bed rest for 24 to 48 hours, edema distention with the pressure; ii) 2nd degree—it is an irreversible lymphedema with prolonged rest, fibrosis in the subcutaneous tissue of moderate to severe edema distention with the pressure; iii) 3rd degree—refers to the irreversible lymphedema with severe fibrosis in the subcutaneous tissue and elephant aspect of the member.

Lymphedema provides various forms of treatment, such as application of pressure on the affected part, stimulating the lymphatic drainage system via the use of clamp or other types of compression garments, such as presented in document no. BR 20 2012 031351 6 consisting of an ergonomic bra for mastectomized women with lymphedema, comprising a garment having a garment for therapeutic purposes, in a two-piece, or a bra conjunction with raglan sleeve, produced with technological tissue compression and the base of the bra has sufficient width to embrace the body; it conceives a raglan sleeve attached to the bra body to form one piece, and the raglan sleeve may or may not be provided with metacarpophalangeal gloves; bra and Raglan sleeve have an opening in the lower portion; bra has a front zip that may be zipper or hook, and for mastectomy breast it has an internal support.

Another document found in no. CN2936207 presents cylindrical sock to upper limb and a lower half mask that is correspondingly opened and closed, an inlet and an outlet respectively provided in the middle of a flank of the upper and lower, a heating rod and a shell uniformly distributed within the body.

Another form of treatment consists of the elevation of the affected limb and member tenure for a certain time, and, for the immobilization of the upper limb, it has been found a document of no. U.S. Pat. No. 8,590,848 which includes a first and a second base, each of which may be selected by the user to raise the arm appropriately depending on the user's body position. A top channel includes a concave and arcuate surface to accommodate the arm of the patient. The upper channel is linear in order to maintain the arm in a linear direction and without any elbow bends and with a minimum bend in the armpit. The elevation device includes a foam core surrounded by a fabric cover.

It happens that, the said apparatus does not provide proper ergonomics for use for long periods, making the treatment difficult and uncomfortable to the patient.

Aware of the numerous drawbacks for the treatment of lymphedema, the applicant holds the document no. PI 0005369-4 which refers to physiotherapy apparatus of lymphatic drainage, which is comprised of a single small piece, consisting of a quadrangular laminate base, on which are arranged two interlocking mechanisms, being one mechanical and other electro-electronics, interconnected by levers system; the mechanical system is composed of a pair of thresholds formed of two identical platforms, capable of moving alternately and intermittently in angle ranging from 60° to 90°, through the electronics mechanism and lever system.

### SUMMARY

Thus, considering the provision of improvements to the consumer market, the applicant has developed this constructive disposition introduced in physiotherapy electromechanical apparatus of lymphatic drainage for upper members of the type used in the treatment of lymphedema, wherein the said apparatus comprises a conditioner fairing responsible for a mechanical module movement installed in the upper base of the fairing, in turn, this mechanical module formed by a connecting rod that angularly moves a pivotable platform installed on a support pedestal and devised for accommodation of the arm and forearm of the patient.

The constructive improvements in the physiotherapy apparatus comprises mainly a constituent of a composite and compact fairing, a horizontal receptacle that allows packaging of the electromechanical module, providing greater safety during handling of the upper limb, as well as the compact fairing that comprises a suitable space area for the installation of mechanical module designed for angular movement of the pivotable platform, in order to compose an appropriate peripheral space for the positioning of the upper limb.

Another improvement consists of the new configuration of the accommodation platform of the upper limb to reduce the possibility of friction skin lesion in the bending of the elbow.

Likewise, the platform comprising each doorway has a new innovated angulation made possible by the innovated structure of the pedestal and levers, and, consequently, the change of the angle of flexion and plantar extension of the patient.

Another improvement in the apparatus consists of the addition of a cushion to raise the member to prevent bedsore of decubitus type due to repeated movements of a higher frequency.

Another improvement lies in the fact the apparatus displays control panel for ease of use with the digitization of commands.

The association of all the constructive improvements in the electromechanical device allows the possibility of intensive treatment of lymphedema with large volume decreases in a short period of time.

### DESCRIPTION OF THE FIGURES

To complement the present description in order to obtain a better understanding of the features of the utility model and according to a preferred practical embodiment thereof, a set of drawings accompanies the description attached, where, in exemplified way, although not limiting, represented as follows:

FIG. 1 is a perspective view of physiotherapy electromechanical apparatus of lymphatic drainage innovated herein;

FIG. 2 reveals a top view; and

FIGS. 3A and 3B show partial sectional views illustrating the movement of the pivoting platform of the upper members.

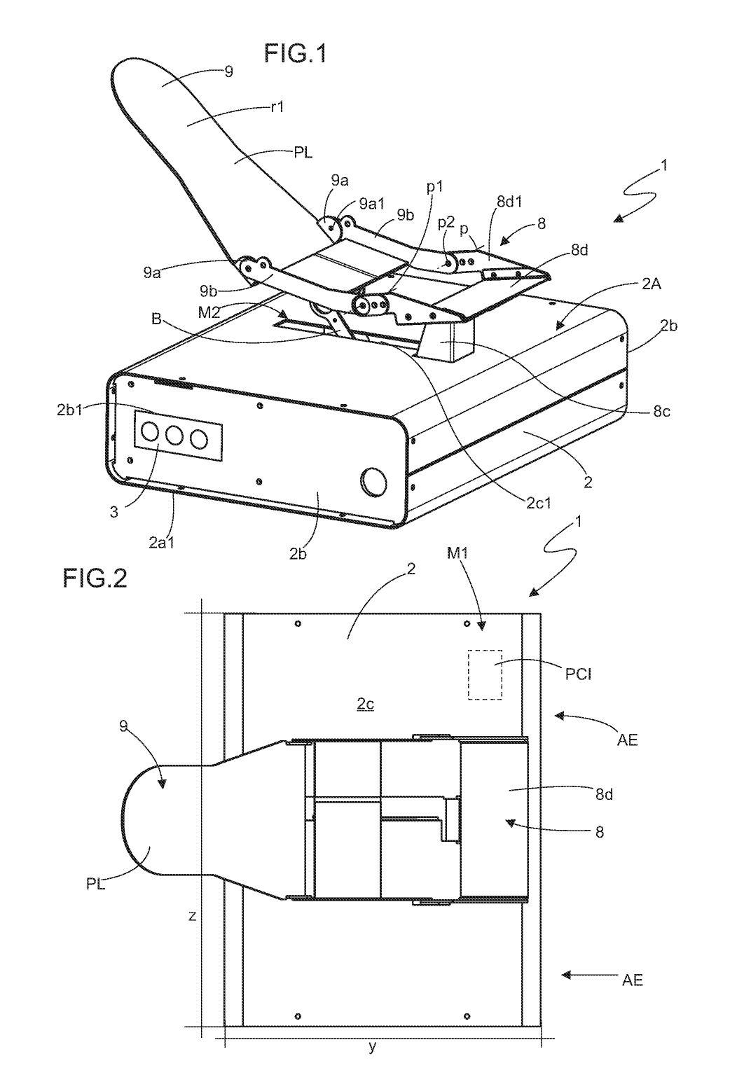

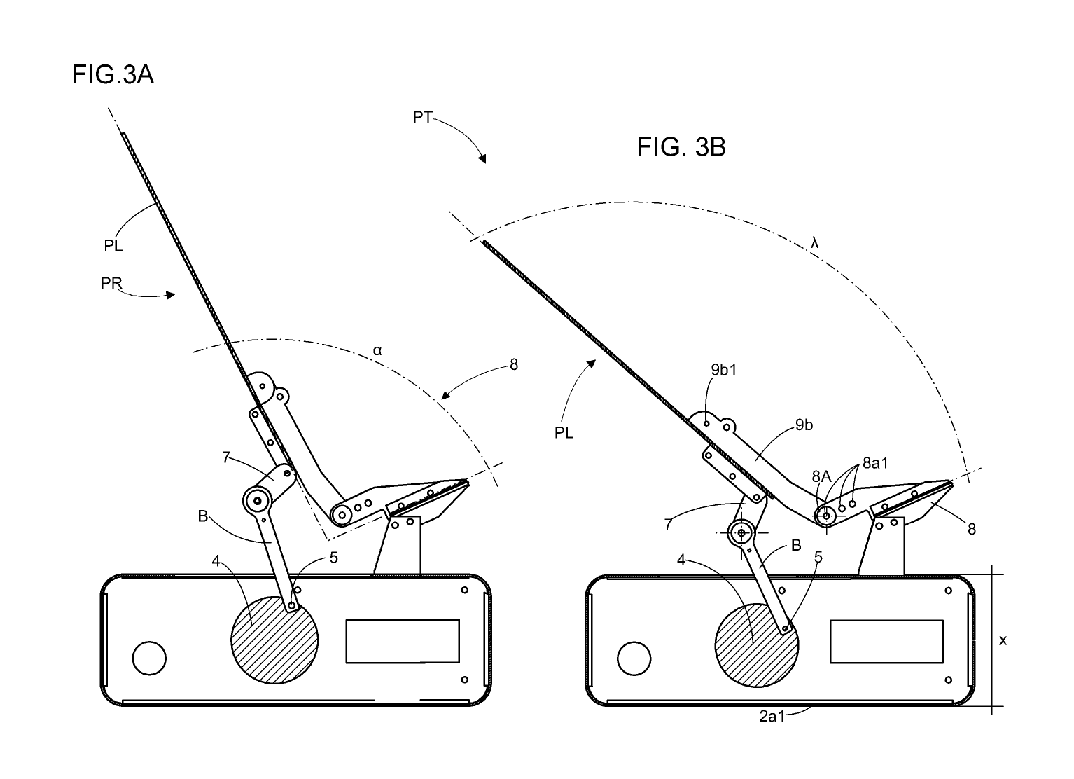

### DETAILED DESCRIPTION

With reference to the illustrated drawings, the present application refers to a “CONSTRUCTIVE DISPOSITION INTRODUCED IN PHYSIOTHERAPY ELECTROMECHANICAL APPARATUS OF LYMPHATIC DRAINAGE FOR UPPER LIMBS,” more precisely it is electromechanical apparatus (1) of the type used in the treatment of lymphedema or other similar diseases; the said apparatus (1) provides associated mechanisms, with the electromechanical module (M1) formed by a printed circuit board (PCI) and idealized for actuating the mechanical module (M2), which in turn imposes movement to a rod (B), which is connected to a support platform (PL) of the upper member (not shown). The said platform (PL) promotes angular and repetitive motion of the upper limb. The said constructiveness of the apparatus (1) is required in the document filed by the applicant no. P0703391-5 deposited on Aug. 13, 2007.

According to the present application, the electromechanical mechanism (M1) and mechanism (M2) are packaged in compact fairing (2) of rectangular prism shape and configured by a receptacle (2A) of low height (x), width (y) and length (z) whose flat bottom (2a1) is installed the printed circuit board (PCI), which is connected to a command digital panel (3) controller of all functions of the apparatus (1), wherein the said panel (3) is disposed in recess (2b1) carried on one of the side walls (2b) of the receptacle (2A), whereas the mechanical module (M2) formed by the gearmotor (4) that drives the eccentric shaft system (5) which imposes rotating motions to the rod (B). The said receptacle (2A) provides in the top wall (2c) recess (2c1) for centralized installation of the mechanical module (M2) and, therefore, the fixing of the rod (B) in an orthogonal branch (7) extending from the lower face of the platform (PL).

The assembly of the modules (M1) and (M2) in the fairing (2) configure a spatial area (AE) wide and centered to the angular movement of the support platform (PL) of the upper member.

In a preferred constructive version, the platform (PL) is pivotable in points (p1) and (p2) foreseen in extreme members (8A) extending from the side edges of the pedestal (8) installed on the top wall (2c) of the fairing (2), wherein the said pedestal (8) is aligned with the recess (2c1) for the centering of the platform (PL) which, in turn, is configured by a thin part (9) of oblong shape whose edges develop short projections (9a) where are practiced holes (9A1) for mounting of regulator arms (9b). The free ends of each arm (9b) provides hole (9b1) for the mounting of retaining pins (p) to pierce holes (8a1) charged in the end-members (8A) configuring the coupling points (p1) and (p2).

The said thin part (9) has rounded top edge followed by core bandaging, wherein the contact face with the upper limb of the patient may receive suitable coating (c1).

The said pedestal (8) is formed by frustoconical prismatic body (8c) in whose end portion is fixed angularly a rectangular plate (8d) with side edges provided with folds in order to compose walls (8d1) where are developed the extreme members (8A). In each member (8A) holes are practiced (8a1) that provide the regulation of arms (9b).

Thus, the rest position (PR) of the platform (PL) and pedestal (8) form angles (α), preferably of 88°, while in the pivoted position (PT) of the platform (PL) associated with the fixed angle of the pedestal (8) forms the angle (λ), preferably 130°, and the repetitive movement by the eccentric shaft (5) of the platform (PL) changes the angles, promoting flexion and extension of the arm and forearm of the patient.

The physiotherapy electromechanical apparatus has significant advantages over the prior art documents, and it fits perfectly in the criteria that define the application, i.e., performs the combination and modification of elements already known, bringing new shape or disposal, resulting in functional improvement in its use or manufacture.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

1) “CONSTRUCTIVE DISPOSITION INTRODUCED IN PHYSIOTHERAPY ELECTROMECHANICAL APPARATUS OF LYMPHATIC DRAINAGE FOR UPPER LIMBS,” more precisely it is electromechanical device (1) of the type used in the treatment of lymphedema or other similar diseases; said apparatus (1) provides associated mechanisms, with the electromechanical module (M1) formed by a printed circuit board (PCI) and idealized for actuating the mechanical module (M2), which in turn imposes movement to a rod (B), which is connected to the support platform (PL) of the upper member; the said platform (PL) promotes angular and repetitive motion of the upper limb; characterized by electromechanical mechanism (M1) and mechanism (M2) to be packed in compact fairing (2) of rectangular prism shape and configured by a receptacle (2A) of low height (x), width (y) and length (z) in which flat bottom (2a1) is installed the printed circuit board (PCI), which is connected to a digital control panel (3) controller of all the functions of the apparatus (1), wherein the said panel (3) is disposed in cutout (2b1) carried on one of the side walls (2b) of the receptacle (2A), whereas the mechanical module (M2) formed by the gearmotor (4) that drives the eccentric shaft system (5), which imposes rotating movements to the rod (B); the said receptacle (2A) provides in the top wall (2c) recess (2c1) for centralized installation of the mechanical module (M2) and thus fixing of the rod (B) in an orthogonal branch (7) extending from the lower face of the platform (PL); assembly of the modules (M1) and (M2) in the fairing (2) configure a spatial area (LA) wide and centered to the angular movement of the support platform (PL) of the upper member; the (PL) is pivotable in points (p1) and (p2) predicted in extreme members (8A) extending from the side edges of the pedestal (8) installed on the top wall (2c) of the fairing (2), wherein the said pedestal (8) is aligned with the recess (2c1) for the centering of the platform (PL) which, in turn, is configured by a thin part (9) of oblong shape whose edges develop short projections (9a) where holes are charged (9A1) for the assembly of regulator arms (9b); the free ends of each arm (9b) provides hole (9b1) for the assembly of retaining pins (P) to pierce holes (8a1) charged in end-members (8A) configuring the coupling points (p1) and (p2); the said thin part (9) has rounded top edge followed by core bandaging, wherein the contact face with the upper limb of the patient may receive suitable coating (c1); the said pedestal (8) is formed by frustoconical prismatic body (8c) in whose end portion is fixed angularly a rectangular plate (8d) with side edges provided with folds in order to compose walls (8d1) where are developed the extreme members (8A); in each member (8A) holes are practiced (8a1) that provide the regulation of arms (9b).

2) “CONSTRUCTIVE DISPOSITION INTRODUCED IN PHYSIOTHERAPY ELECTROMECHANICAL APPARATUS OF LYMPHATIC DRAINAGE FOR UPPER LIMBS,” according to the preceding claim, characterized by the rest position (RP) of the platform (PL) and pedestal (8) form angles (α) of 88°.

3) “CONSTRUCTIVE DISPOSITION INTRODUCED IN PHYSIOTHERAPY ELECTROMECHANICAL APPARATUS OF LYMPHATIC DRAINAGE FOR UPPER LIMBS,” according to claim 1, characterized by articulated position (PT) of the platform (PL) associated with the fixed angle of the pedestal (8) compose angle (λ) of 130°, and the repetitive movement by the eccentric shaft (5) of the platform (PL) changes the angles for flexion and extension of the arm and the forearm of the patient.
